(19) United States
(12) Patent Application Publication
(10) Pub. No.: US 2007/0201961 A1
(43) Pub. Date: Aug. 30, 2007

(54) Drill guide used in woodworking for preparing pocket joints

(76) Inventor: Vance Chiang, Taichung City (TW)

Correspondence Address: Vance Chiang, 5F.-2, No.212, Sec. 1, Wunsin Rd., Taichung City, 408, TW

(21) Appl. No.: 11/403,748

(22) Filed: Apr. 14, 2006

(30) Foreign Application Priority Data
Feb. 27, 2006 (TW) 095203264

(51) Int. Cl. B23B 47/28

(52) U.S. Cl. 408/115 R

(57) ABSTRACT

A drill guide used in woodworking for preparing pocket joints includes a guide member with a cuboid body. The cuboid body has an inclined plane formed on a front end thereof and a cavity defined in the front end thereof. The cavity has two opposite ends respectively and slantingly extending to the inclined plane and the first datum plane. A guide sleeve is longitudinally and detachably mounted in the front end of the cuboid body and abuts the inclined plane. The guide sleeve extends into the cavity for guiding a drill bit into the cavity and drilling an inclined hole in the workpiece. The cuboid body has a second datum plane formed on a rear end thereof. An axis of the drill bit passes through a central plane of the workpiece on a rear distal edge when the second datum plane aligns with the rear distal edge.

### BACKGROUND OF THE INVENTION

1. Field of the Invention

The present invention relates to a woodworking apparatus, and more particularly to a drill guide used for preparing pocket joints.

2. Description of Related Art

U.S. Pat. No. 4,955,766 discloses a holding fixture for drilling pocket joints, in which a drilling bit 1 is used having a pocket forming portion and a smaller diameter pilot hole forming portion for drilling pocket joints (pilot hole 3 and pocket 4) on workpieces 2 and 2A for mounting screws 5, and an over-center toggle clamp is used for holding the workpiece. According to U.S. Pat. No. 4,955,766, a guide line must be marked on the workpiece before drilling pocket joints, and when a pilot hole is formed, the workpiece must be fixed in position by the over-center toggle clamp so that the desired pocket can be processed. However, the disclosure of U.S. Pat. No. 4,955,766 does not provide any means for drawing off wood chips during drilling. Deposited wood chips will affect the quality of the pocket joints, and may cause the drill bit to be damaged. Furthermore, the disclosure of U.S. Pat. No. 4,955,766 can only drill a pocket of fixed specification.

The present invention has arisen to mitigate and/or obviate the disadvantages of the conventional woodworking apparatus.

### SUMMARY OF THE INVENTION

The main objective of the present invention is to provide an improved drill guide used in woodworking for preparing pocket joints. The present invention can be adjusted corresponding to the thickness of the workpiece.

To achieve the objective, the drill guide in accordance with the present invention comprises a guide member with a cuboid body. The cuboid body has a first datum plane form on a bottom thereof for abutting a top surface of a workpiece during operating. The cuboid body has an inclined plane formed on a front end thereof and a cavity defined in the front end thereof. The cavity has two opposite ends respectively and slantingly extending to the inclined plane and the first datum plane. A guide sleeve is longitudinally and detachably mounted in the front end of the cuboid body and abuts the inclined plane. The guide sleeve extends into the cavity for guiding a drill bit into the cavity and drilling an inclined hole in the workpiece. The cuboid body has a second datum plane formed on a rear end thereof and perpendicular to the first datum plane. An axis of the drill bit passes through a central plane of the workpiece on a rear distal edge of the workpiece when the second datum plane aligns with the rear distal edge of the workpiece. For ensuring the axis of the drill bit passing through the central plane of the workpieces with different thickness, a stretch block is longitudinally attached to the second datum plane for changing a distance between the second datum plane and the rear distal edge of the workpiece.

Further benefits and advantages of the present invention will become apparent after a careful reading of the detailed description with appropriate reference to the accompanying drawings.

### BRIEF DESCRIPTION OF THE DRAWINGS

FIG. 1 is a perspective schematic view of a drill guide used in woodworking for preparing pocket joints in accordance with the present invention;

FIG. 2 is an exploded perspective view of the drill guide of the present invention with two stretch blocks;

FIG. 3 is a perspective view of the drill guide of the present invention;

FIG. 4 is a cross-sectional view of the drill guide in FIG. 3 along line A-A;

FIG. 5 is another perspective schematic view of a drill guide used in woodworking for preparing pocket joints in accordance with the present invention

FIG. 6 is a perspective view of a second embodiment of the drill guide of the present invention;

FIG. 7 is an exploded perspective view of the drill guide in FIG. 6 with two stretch blocks;

FIG. 8 is a perspective schematic view of the drill guide in FIG. 6 with a first stretch block;

FIG. 9 is a perspective schematic view of the drill guide in FIG. 6 with a second stretch block;

FIG. 10 is a side plan view of the drill guide in FIG. 1;

FIG. 11 is a first operational view in partial cross-section of the drill guide in FIG. 6 when adjusting the distance between the two guide members; and

FIG. 12 is a second operational view in partial cross-section of the drill guide in FIG. 6 when adjusting the distance between the two guide members.

### DETAILED DESCRIPTION OF THE INVENTION

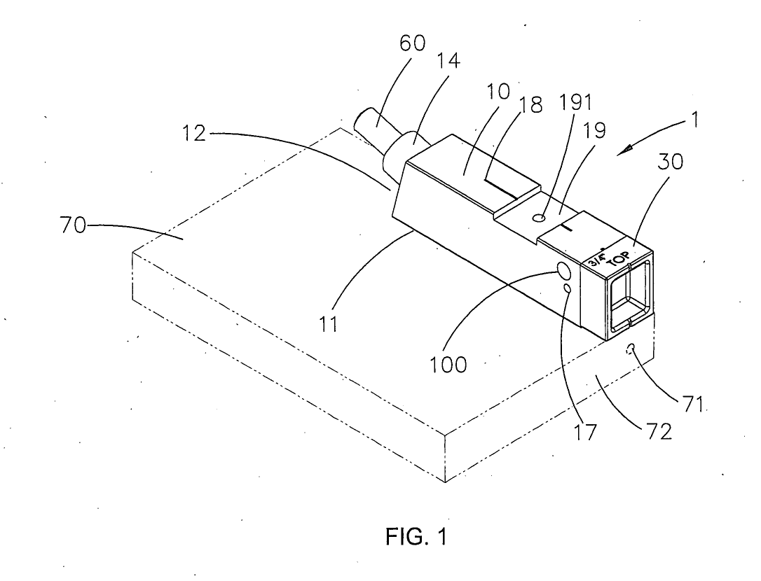

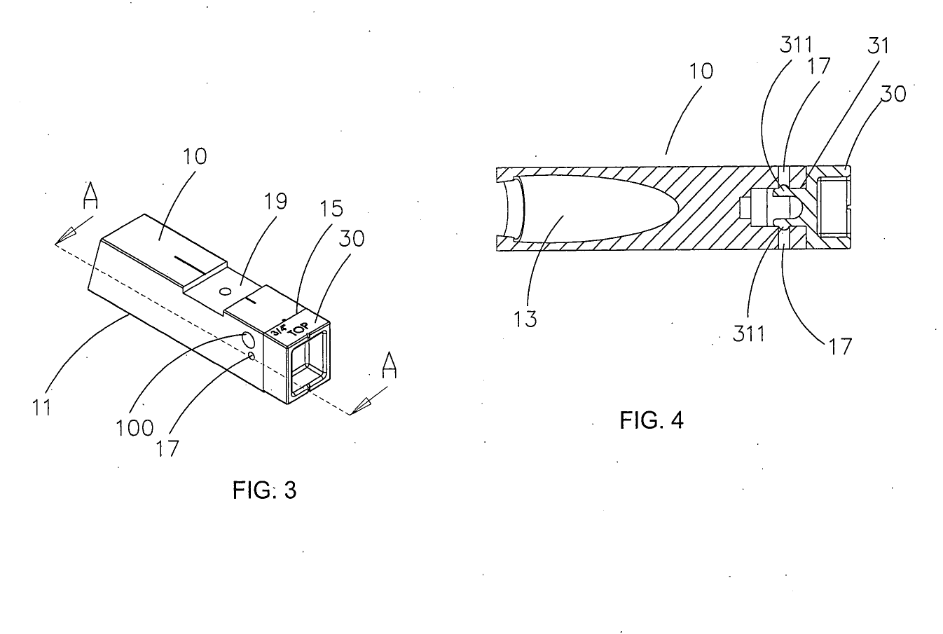

Referring to the drawings and initially to FIGS. 1-5, a drill guide used in woodworking for preparing pocket joints in. accordance with the present invention comprises a first guide member (1) with a cuboid body (10). The cuboid body (10) has a first datum plane (11) form on a bottom thereof for abutting a top surface of a workpiece (70) during operating. With reference to FIGS. 3 and 4, the cuboid body (10) has an inclined plane (12) formed on a front end thereof and a cavity (13) defined in the front end thereof. The cavity (13) has two opposite ends respectively and slantingly extends to the inclined plane (12) and the first datum plane (11) of the cuboid body (10). A guide sleeve (14) is longitudinally and detachably mounted in the front end of the cuboid body (10) and abuts the inclined plane (12). The guide sleeve (14) extends into the cavity (13) for guiding a drill bit (60) into the cavity (13) and drilling an inclined hole (71) in the workpiece. The guide sleeve (14) is made of hardened material to prevent the cuboid body (10) from being damaged by the operating drill bit (60). In addition, the guide sleeve (14) is detachably mounted in the front end of the cuboid body (10) such that the guide sleeve (14) can be replaced for corresponding to the diameter of the drill bit (60).

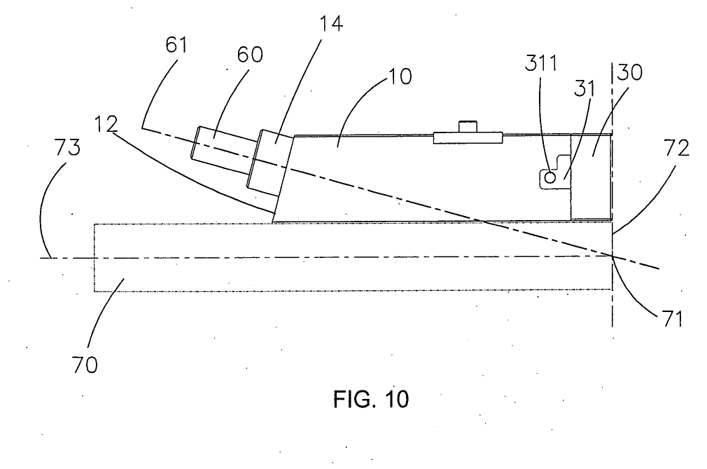

The cuboid body (10) has a second datum plane (15) formed on a rear end thereof and perpendicular to the first datum plane (11). With reference to FIG. 10, an axis (61) of the drill bit (60) passes through a central plane (73) of the workpiece (70) on a rear distal edge (72) of the workpiece (70) when the second datum plane (15) aligns with the rear distal edge (72) of the workpiece (70). Consequently, the inclined hole (71) extending through the workpiece (70) in the rear distal edge (72) and on the central plane of the workpiece (70). As a result, the two jointed workpieces (70) has a good connection and the workpiece (70) is not easily cracked during jointing.

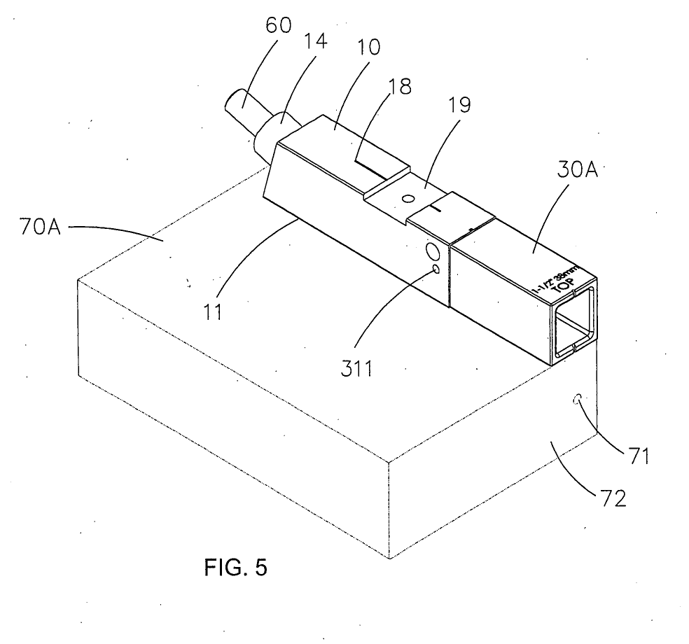

For ensuring the axis (61) of the drill bit (60) passing through the central plane (73) of the workpieces (70) with different thickness, an stretch block (30) is longitudinally attached to the second datum plane (15), as shown in FIG. 1, for changing a distance between the second datum plane (15) and the rear distal edge (72) of the workpiece (70). The length of the stretch block (30) corresponds to the thickness of the workpiece (70). With reference to FIG. 5, the stretch block (30A) has a length longer than that of the stretch block (30) in FIG. 1 because the workpiece (70A) in FIG. 5 has a thickness thicker than the workpiece (70) in FIG. 1.

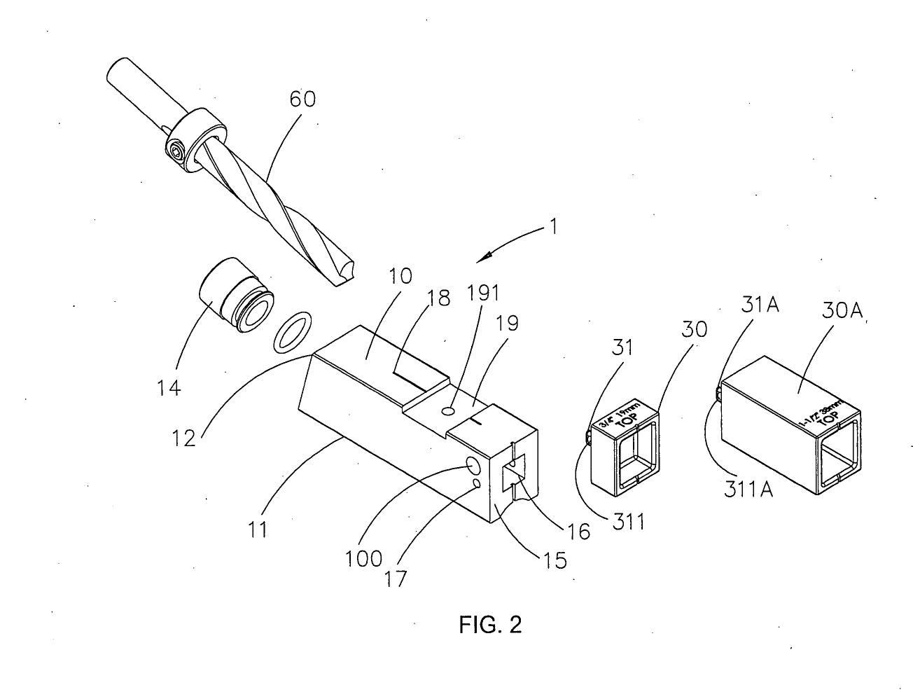

With reference to FIG. 2, for connecting the stretch block (30/30A), the cuboid body (10) has a cubic hole (16) longitudinally defined in the second datum plane (15) and the stretch block (30/30A) has a connector (31/31A) longitudinally extending from the stretch block (30/30A). The connector (31/31A) is received in the cubic hole (16) when the stretch block (30/30A) connected to the cuboid body (10). The cuboid body (10) has a first through hole (17) laterally defined therein and perpendicularly communicating with the cubic hole (16). The connector (31/31A) has two bosses (311/311A) respectively formed on to opposite sides of the connector (31/31A). With reference to FIGS. 4 and 5, the two bosses (311/311A) are respectively engaged into the first through hole (17) for promoting the connection between the cuboid (10) and the stretch block (30/30A) when the stretch block (30/30A) mounted to the second datum plane (15) of the cuboid body (10).

With reference to FIG. 10, the bottom of the stretch block (30) and the first datum plane (11) of the cuboid body (10) align with each other for user to conveniently align the distal end of the stretch block (30) with the rear distal edge (72) of the workpiece (70) when the stretch block (30) attached to the second datum plane (15) of the cuboid body (10).

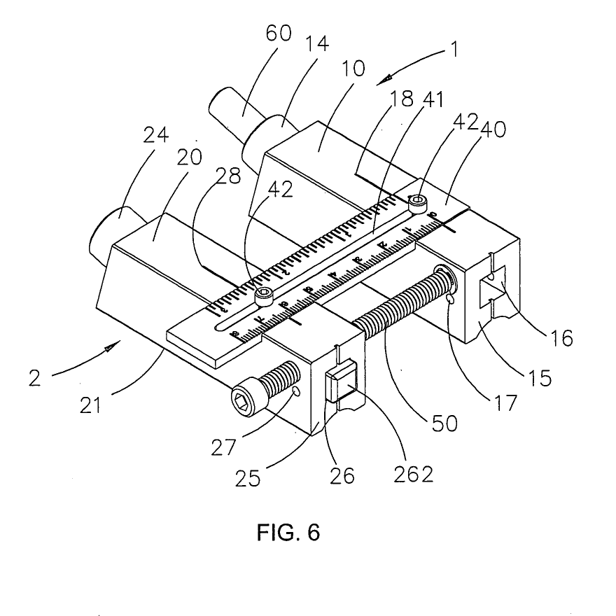

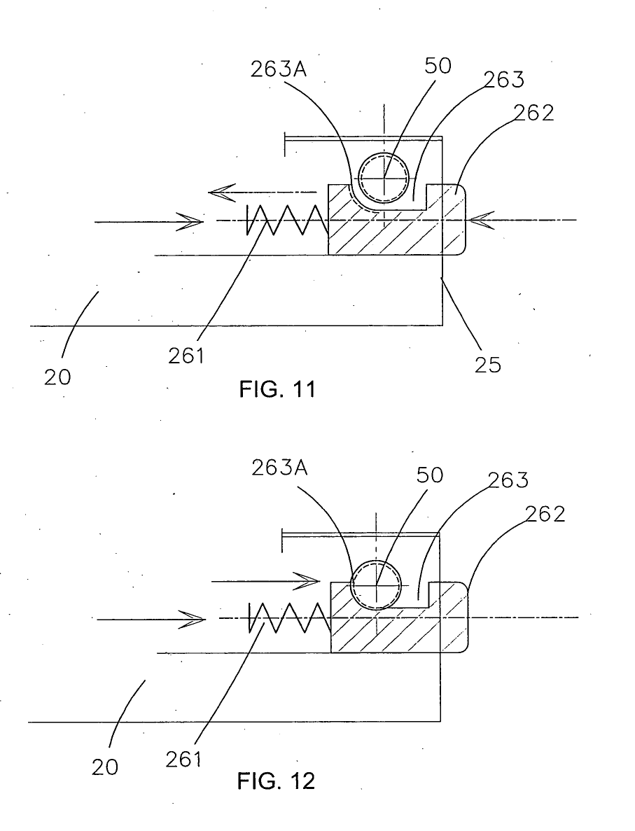

With reference to FIGS. 6 to 9 and 11 to 12 that show a second embodiment of the present invention, the embodiment further comprises a second guide member (2). The second guide member (2) has a structure which is identical to that of the first guide member (1). The second guide member (2) includes a cuboid body (20), a first datum plane (21), an inclined plane (22), a cavity (23), a guide sleeve (24), a second datum plane (25), a cubic hole (26) and a first through hole (27). The second guide member (2) can be laterally and horizontally moved relative to the first guide member (1). Consequently, the operator only need set the first guide member (1) and the second guide member (2) at one time and can drill two parallel inclined holes (71) in a workpiece (70) or in two different workpieces (70).

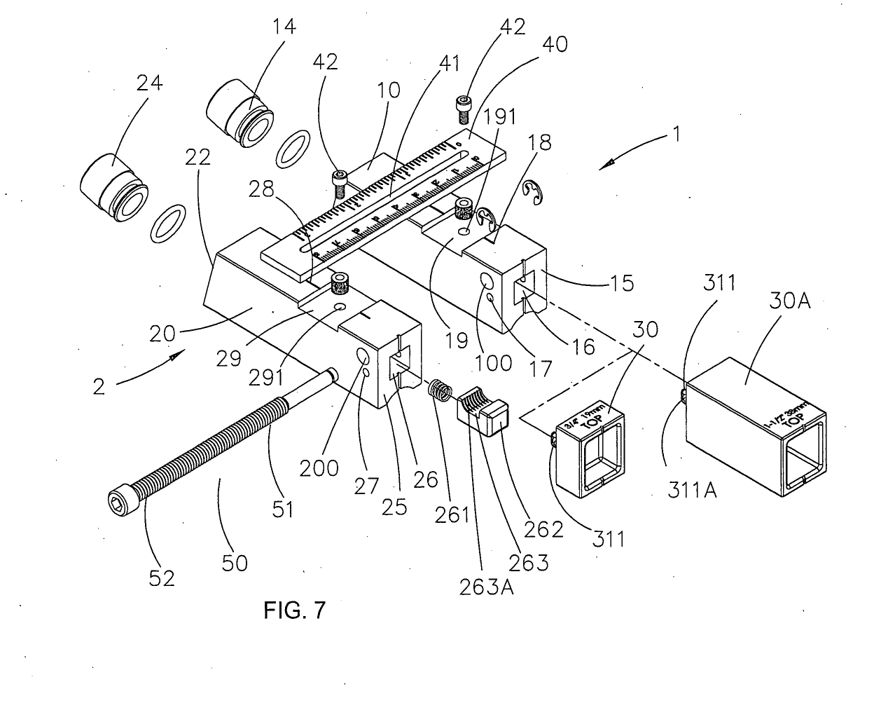

For controlling the distance between the first guide member (1) and the second guide member (2), a ruler (40) is provided to connect the first guide member (1) and the second guide member (2). The ruler (40) has two opposite ends respectively and selectively secured on two tops of the first guide member (1) and the second guide member (2). With reference to FIGS. 6 and 7, the ruler (40) has a slot (41) longitudinally defined therein. Two bolts (42) respectively extend through the slot (41), and screwed into the tops of the first guide member (1) and the second guide member (2) to assemble the first guide member (1), the second guide member (2) and the ruler (40). The second guide member (2) can be laterally and horizontally moved relative to the first guide member (2) when the two bolts (42) are loosened. The two bolts (42) are tightened to the first guide member (1) and the second guide member (2) for drilling inclined holes (71) when the second guide member (2) is moved to a desired place.

The ruler (40) has a British measure system and a metric measure system respectively formed on two opposite sides thereof for user to easily read the movement of the second guide member (2) relative to the first guide member (1). With reference to FIG. 6, each top of the first guide member (1) and the second guide member (2) has two notches (18/28) defined therein and corresponding to the two opposite sides of the ruler (40) for indicating the scale on the ruler (40).

With reference to FIG. 7, the first guide member (1) and the second guide member (2) respectively has a recess (19/29) defined in the top thereof for partially receiving the ruler (40) and a threaded hole (191/291) defined in a bottom of each of the two the recess (19/29) for partially receiving the two bolts (42) after extending through the slot (41) in the ruler (40). In addition, each recess (19/29) has a depth that is equal to a thickness of the ruler (40).

For accurately adjusting the distance between the first guide member (1) and the second guide member (2), a lead screw (50) is reparably mounted between the first guide member (1) and the second guide member (2). The first guide member (1) and the second guide member (2) respectively has a second through hole (100/200) laterally defined therein. The second through hole (100/200) perpendicularly communicates with the cubic hole (16/26). The lead screw (50) has a first end pivotally received in the second through hole (100) in the first guide member (1) and a second end extending through the second through hole (200) in the second guide member (2). A spring (261) and a clutch (262) are sequentially mounted in the cubic hole (26) in the second guide member (2). The clutch (262) has a U-shaped groove (263) defined therein for allowing the lead screw (50) extending through the second through hole (200) in the second guide member (2). The clutch (262) has a threaded portion (263A) formed thereon and corresponding to the spring (261). The threaded portion (263A) is provided to selectively engage to the lead screw (50).

With reference to FIGS. 7 and 11-12, the bolts (42) are firstly released when adjusting the distance between the first guide member (1) and the second guide member (2). The clutch (262) is inward pushed to make the threaded portion (263A) disengage from the lead screw (50) and compress the spring (261). As a result, the second guide member (2) can be freely moved relative to the first guide member (1).

The clutch (262) is released when the second guide member (2) is moved and near the desired place. The threaded portion (263A) of the clutch (262) is immediately engaged to the lead screw (50) due to a restitution force of the spring (261). Then, the operator can accurately adjust the distance between first guide member (1) and the second guide member (2) by rotating the lead screw (50). The bolts (42) are tightened again to fix the first guide member (1), the second guide member (2) and the ruler (40) when the second guide member (2) is accurately adjusted to the desired place.

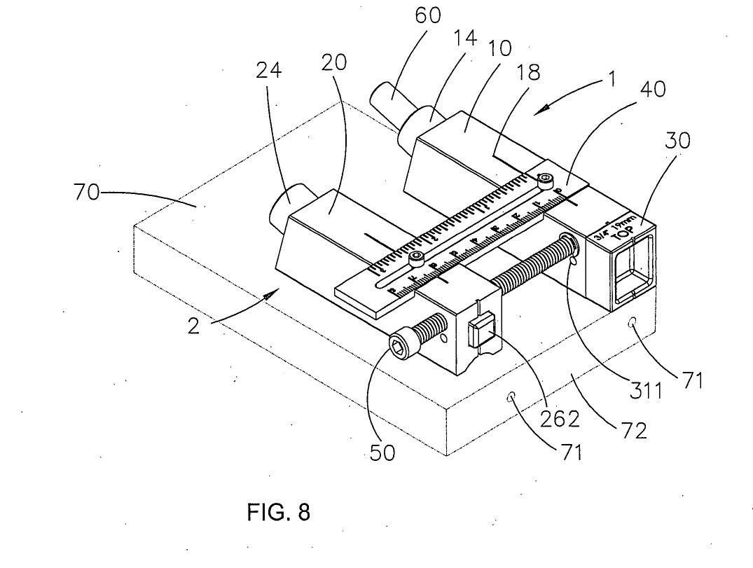

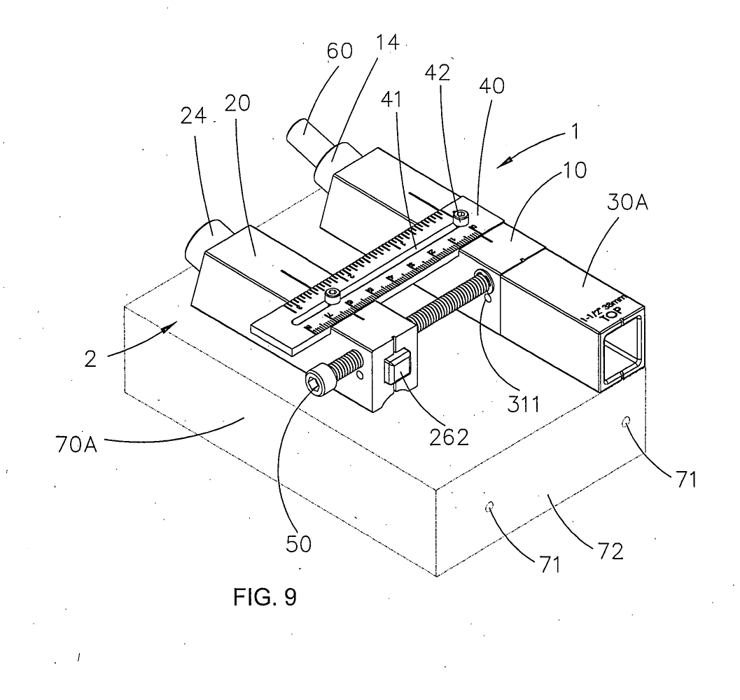

With reference to FIGS. 8-10, for ensuring the axis (61) of the drill bit (60) passing through the central plane (73) of the workpieces (70) with different thickness, an stretch block (30) is longitudinally attached to the second datum plane (15), as shown in FIGS. 8 and 10, for changing a distance between the second datum plane (15) and the rear distal edge (72) of the workpiece (70). The length of the stretch block (30) corresponds to the thickness of the workpiece (70). With reference to FIG. 9, the stretch block (30A) has a length longer than that of the stretch block (30) in FIG. 8 because the workpiece (70A) in FIG. 9 has a thickness thicker than the workpiece (70) in FIG. 8.

With reference to FIG. 10, as described above, the second through hole (100) communicates with the cubic hole (16) such that the connector (31/31A) is designed to have an L-shape to prevent the connector (31/31A) from colliding with the lead screw (50) when attaching the stretch block (30/30A) to the first guide member (1).

Although the invention has been explained in relation to its preferred embodiment, it is to be understood that many other possible modifications and variations can be made without departing from the spirit and scope of the invention as hereinafter claimed.

What is claimed is:

1. A drill guide used in woodworking for preparing pocket joints, comprising a guide member with a cuboid body, the cuboid body having a first datum plane form on a bottom thereof for abutting a top surface of a workpiece during operating, the cuboid body having an inclined plane formed on a front end thereof and a cavity defined in the front end thereof, the cavity having two opposite ends respectively and slantingly extending to the inclined plane and the first datum plane of the cuboid body, a guide sleeve longitudinally and detachably mounted in the front end of the cuboid body and abuts the inclined plane, the guide sleeve extending into the cavity for guiding a drill bit into the cavity and drilling an inclined hole in the workpiece, the cuboid body having a second datum plane formed on a rear end thereof and perpendicular to the first datum plane, an axis of the drill bit passing through a central plane of the workpiece on a rear distal edge of the workpiece when the second datum plane aligns with the rear distal edge of the workpiece, for ensuring the axis of the drill bit passing through the central plane of the workpieces with different thickness, an stretch block longitudinally attached to the second datum plane for changing a distance between the second datum plane and the rear distal edge of the workpiece.

2. The drill guide as claimed in claim 1, wherein the guide sleeve is made of hardened material to prevent the cuboid body from being damaged by the operating drill bit.

3. The drill guide as claimed in claim 1, wherein the cuboid body has a cubic hole longitudinally defined in the second datum plane and the stretch block has a connector longitudinally extending from the stretch block, the connector received in the cubic hole when the stretch block is connected to the cuboid body, the cuboid body having a first through hole laterally defined therein and perpendicularly communicating with the cubic hole, the connector having two bosses respectively formed on to opposite sides of the connector, the two bosses respectively engaged into the first through hole for promoting the connection between the cuboid and the stretch block when the stretch block is mounted to the second datum plane of the cuboid body.

4. The drill guide as claimed in claim 2, wherein the cuboid body has a cubic hole longitudinally defined in the second datum plane and the stretch block has a connector longitudinally extending from the stretch block, the connector received in the cubic hole when the stretch block is connected to the cuboid body, the cuboid body having a first through hole laterally defined therein and perpendicularly communicating with the cubic hole, the connector having two bosses respectively formed on to opposite sides of the connector, the two bosses respectively engaged into the first through hole for promoting the connection between the cuboid and the stretch block when the stretch block is mounted to the second datum plane of the cuboid body.

5. A drill guide used in woodworking for preparing pocket joints, comprising:
a first guide member with a cuboid body, the cuboid body having a first datum plane form on a bottom thereof for abutting a top surface of a workpiece during operating, the cuboid body having an inclined plane formed on a front end thereof and a cavity defined in the front end thereof, the cavity having two opposite ends respectively and slantingly extending to the inclined plane and the first datum plane of the cuboid body, a guide sleeve longitudinally and detachably mounted in the front end of the cuboid body and abuts the inclined plane, the guide sleeve extending into the cavity for guiding a drill bit into the cavity and drilling an inclined hole in the workpiece, the cuboid body having a second datum plane formed on a rear end thereof and perpendicular to the first datum plane, an axis of the drill bit passing through a central plane of the workpiece on a rear distal edge of the workpiece when the second datum plane aligns with the rear distal edge of the workpiece, for ensuring the axis of the drill bit passing through the central plane of the workpieces with different thickness, an stretch block longitudinally attached to the second datum plane for changing a distance between the second datum plane and the rear distal edge of the workpiece;
a second guide member with a cuboid body connected to the first guide member and can be moved relative to the first guide member, the cuboid body of the second guide member having a structure similar to that of the cuboid body of the first guide member, the cuboid body of the second guide member having a first datum plane form on a bottom thereof for abutting a top surface of a workpiece during operating, the cuboid body having an inclined plane formed on a front end thereof and a cavity defined in the front end thereof, the cavity having two opposite ends respectively and slantingly extending to the inclined plane and the first datum plane of the cuboid body, a guide sleeve longitudinally and detachably mounted in the front end of the cuboid body and abuts the inclined plane, the guide sleeve extending into the cavity for guiding a drill bit into the cavity and drilling an inclined hole in the workpiece, the cuboid body having a second datum plane formed on a rear end thereof and perpendicular to the first datum plane; and
a ruler provided to connect the first guide member and the second guide member, the ruler having two opposite ends respectively and selectively secured on two tops of the first guide member and the second guide member, the ruler having a slot longitudinally defined therein, two bolts respectively extend through the slot, and screwed into the tops of the first guide member and the second guide member to assemble the first guide member, the second guide member and the ruler.

6. The drill guide as claimed in claim 5, wherein the guide sleeve is made of hardened material to prevent the cuboid body from being damaged by the operating drill bit.

7. The drill guide as claimed in claim 5, wherein the cuboid body has a cubic hole longitudinally defined in the second datum plane and the stretch block has a connector longitudinally extending from the stretch block, the connector received in the cubic hole when the stretch block is connected to the cuboid body, the cuboid body having a first through hole laterally defined therein and perpendicularly communicating with the cubic hole, the connector having two bosses respectively formed on to opposite sides of the connector, the two bosses respectively engaged into the first through hole for promoting the connection between the cuboid and the stretch block when the stretch block is mounted to the second datum plane of the cuboid body.

8. The drill guide as claimed in claim 6, wherein the cuboid body has a cubic hole longitudinally defined in the second datum plane and the stretch block has a connector longitudinally extending from the stretch block, the connector received in the cubic hole when the stretch block is connected to the cuboid body, the cuboid body having a first through hole laterally defined therein and perpendicularly communicating with the cubic hole, the connector having two bosses respectively formed on to opposite sides of the connector, the two bosses respectively engaged into the first through hole for promoting the connection between the cuboid and the stretch block when the stretch block is mounted to the second datum plane of the cuboid body.

9. The drill guide as claimed in claim 5, wherein the first guide member and the second guide member respectively has a recess defined in the top thereof for partially receiving the ruler and a threaded hole defined in a bottom of each of the two the recess for partially receiving the two bolts after extending through the slot in the ruler, each recess having a depth that is equal to a thickness of the ruler.

10. The drill guide as claimed in claim 5, wherein the ruler has a British measure system and a metric measure system respectively formed on two opposite sides thereof for user to easily read the movement of the second guide member relative to the first guide member, each top of the first guide member and the second guide member having two notches defined therein and corresponding to the two opposite sides of the ruler for. indicating the scale on the ruler.

11. The drill guide as claimed in claim 9, wherein the ruler has a British measure system and a metric measure system respectively formed on two opposite sides thereof for user to easily read the movement of the second guide member relative to the first guide member, each top of the first guide member and the second guide member having two notches defined therein and corresponding to the two opposite sides of the ruler for indicating the scale on the ruler.

12. The drill guide as claimed in claim 5 further comprising a lead screw rotatably mounted between the first guide member and the second guide member for accurately adjusting the distance between the first guide member and the second guide member, the first guide member and the second guide member respectively having a second through hole laterally defined therein, each second through hole perpendicularly communicates with the cubic hole of each of the first guide member and the second guide member, the lead screw having a first end pivotally received in the second through hole in the first guide member and a second end extending through the second through hole in the second guide member, a spring and a clutch sequentially mounted in the cubic hole in the second guide member, the clutch having a U-shaped groove defined therein for allowing the lead screw extending through the second through hole in the second guide member, and a threaded portion formed thereon and corresponding to the spring, the threaded portion provided to selectively engage to the lead screw.

13. The drill guide as claimed in claim 7 further comprising a lead screw rotatably mounted between the first guide member and the second guide member for accurately adjusting the distance between the first guide member and the second guide member, the first guide member and the second guide member respectively having a second through hole laterally defined therein, each second through hole perpendicularly communicates with the cubic hole of each of the first guide member and the second guide member, the lead screw having a first end pivotally received in the second through hole in the first guide member and a second end extending through the second through hole in the second guide member, a spring and a clutch sequentially mounted in the cubic hole in the second guide member, the clutch having a U-shaped groove defined therein for allowing the lead screw extending through the second through hole in the second guide member, and a threaded portion formed thereon and corresponding to the spring, the threaded portion provided to selectively engage to the lead screw.

14. The drill guide as claimed in claim 10 further comprising a lead screw rotatably mounted between the first guide member and the second guide member for accurately adjusting the distance between the first guide member and the second guide member, the first guide member and the second guide member respectively having a second through hole laterally defined therein, each second through hole perpendicularly communicates with the cubic hole of each of the first guide member and the second guide member, the lead screw having a first end pivotally received in the second through hole in the first guide member and a second end extending through the second through hole in the second guide member, a spring and a clutch sequentially mounted in the cubic hole in the second guide member, the clutch having a U-shaped groove defined therein for allowing the lead screw extending through the second through hole in the second guide member, and a threaded portion formed thereon and corresponding to the spring, the threaded portion provided to selectively engage to the lead screw.

15. The drill guide as claimed in claim 12, wherein the second through hole communicates with the cubic hole such that the connector is designed to have an L-shape to prevent the connector from colliding with the lead screw when attaching the stretch block to the first guide member.

16. The drill guide as claimed in claim 13, wherein the second through hole communicates with the cubic hole such that the connector is designed to have an L-shape to prevent the connector from colliding with the lead screw when attaching the stretch block to the first guide member.

17. The drill guide as claimed in claim 14, wherein the second through hole communicates with the cubic hole such that the connector is designed to have an L-shape to prevent the connector from colliding with the lead screw when attaching the stretch block to the first guide member.
